(19) United States
(12) Patent Application Publication
(10) Pub. No.: US 2014/0164840 A1
(43) Pub. Date: Jun. 12, 2014

(54) METHOD AND SYSTEM FOR MONITORING TRANSACTION EXECUTION ON A COMPUTER NETWORK AND COMPUTER STORAGE MEDIUM

(71) Applicant: Tencent Technology (Shenzhen) Company Limited, Shenzhen city, Guangdong Province (CN)

(72) Inventors: Wei Luo, Shenzhen city (CN); Chaojiang Zhan, Shenzhen city (CN); Shuai Yang, Shenzhen city (CN); Yao Zhao, Shenzhen city (CN)

(73) Assignee: Tencent Technology (Shenzhen) Company Limited, Shenzhen City (CN)

(21) Appl. No.: 14/238,650

(22) PCT Filed: Mar. 19, 2013
(86) PCT No.: PCT/CN13/72852

§ 371 Date: Feb. 12, 2014

(30) Foreign Application Priority Data
Apr. 17, 2012 (CN) 201210112854.X

(51) Int. Cl. H04L 12/26

(52) U.S. Cl. CPC H04L 43/0847
USPC 714/37

(57) ABSTRACT

A presentation control method for an interaction interface comprises the following steps: acquiring a contact list and a message of a friend in the contact list; generating an image block corresponding to the friend in the contact list; and presenting the message of the friend in the image block. The aforementioned presentation control method for an interaction interface as well as a real-time communications tool and a computer storage medium generate a corresponding image block for every friend in the contact list, so as to further present the message of the friend in the image block. A user can directly view a message of a friend through an image block in an interface, so that the operation is simplified and the convenience of operations is enhanced.

### FIELD OF THE INVENTION

The invention relates to the technical field of monitoring transaction, particularly to a method and system for monitoring transaction execution on the Internet and computer storage medium.

### BACKGROUND

Various transactions, for example, a third party application on an open platform, a virtual network community, a video broadcasting website, etc, are executed in networks. Generally, the service is provided to the user dependent on its execution environments, the execution environments including various elements for providing logic processing and data storage for the transaction. During the execution process of the transaction, it is necessary to pay attention to failures appearing in the execution environments of the transaction and timely analyze and process the failures.

A traditional method for monitoring transaction monitors each kind of execution environments in real time, the execution environments including network environments, devices such as a server and so on, transaction components, and transaction software etc. If an abnormality is monitored in an execution environment, alarms will be issued in the form of short messages or e-mails, and a person maintaining the transaction can learn of the execution environment in which a failure occurs by viewing contents of the alarms.

However, various kinds of execution environments are interdependent, so as to provide normal and stable operated service. For example, the normal execution of the transaction software depends on the normal execution of the transaction components, and the normal execution of the transaction software and the transaction components depends on the normal execution of execution environments such as the network environments and the server, etc. Therefore, when a failure is monitored in an execution environment of the transaction during the execution process of the transaction, it is usual to issue a large number of alarms to the person maintaining the transaction, which causes the person maintaining the transaction unable to accurately locate the failure.

### SUMMARY OF THE INVENTION

Based on the foregoing contents, it is necessary to provide a method for monitoring transaction execution on Internet which may locate the failures precisely, with regard to the problem of the eruptive large number of alarms.

Besides, it is necessary to provide a system for monitoring transaction execution on Internet which may locate the failures precisely.

Furthermore, it is necessary to provide a computer storage medium for monitoring transaction execution on Internet which may locate the failures precisely.

A method for monitoring transaction execution on the Internet, comprising the steps of:

acquiring monitoring data of a transaction executing on the Internet, and abstracting abnormal data from the monitoring data;

acquiring an abnormal service based on the abnormal data; and

locating a source of execution failure in architecture layers based on the abnormal service.

A system for monitoring transaction execution on the Internet, comprising:

a data monitoring module configured for acquiring monitoring data of a transaction executing on the Internet, and abstracting abnormal data from the monitoring data;

an abnormal service acquiring module configured for acquiring an abnormal service based on the abnormal data; and

a detecting module configured for locating a source of execution failure in architecture layers based on the abnormal service.

A computer storage medium for storing computer executable instructions which are used for controlling the method for monitoring transaction execution on the Internet, the method comprising:

acquiring monitoring data of a transaction executing on the Internet, and abstracting abnormal data from the monitoring data;

acquiring an abnormal service based on the abnormal data; and

locating a source of execution failure in architecture layers based on the abnormal service.

With the method and system for monitoring transaction execution on the Internet and the computer storage medium described above, upon a abnormal service occurs, the source of execution failure is founded by detecting the architecture layers related to the service in accordance with the architecture layers, then it can be determined that whether a failure in each architecture layer is the primary factor that cause the abnormal service, accordingly, the accurately locating of the execution failure can be achieved, which avoids the one by one analysis for the numerous alarms by the person maintaining the transaction.

### DESCRIPTION OF THE DRAWINGS

FIG. 1 is a flow diagram of a method for monitoring transaction execution on the Internet in accordance with an embodiment of the disclosure;

FIG. 2 is a diagram of an architecture hierarchy in accordance with an embodiment of the disclosure;

FIG. 3 is a flow diagram of the processing of locating the source of execution failure in the architecture layers based on the abnormal service in accordance with an embodiment of the disclosure;

FIG. 4 is a flow diagram of the processing of processing the recorded abnormal points in the sequence processing history in the architecture hierarchy to locate the source of execution failure in accordance with an embodiment of the disclosure;

FIG. 5 is a structure diagram of a system for monitoring transaction execution on the Internet in accordance with an embodiment of the disclosure;

FIG. 6 is a structure diagram of the detecting module in accordance with an embodiment of the disclosure;

FIG. 7 is a structure diagram of the detecting module in accordance with another embodiment of the disclosure.

### DETAILED DESCRIPTION

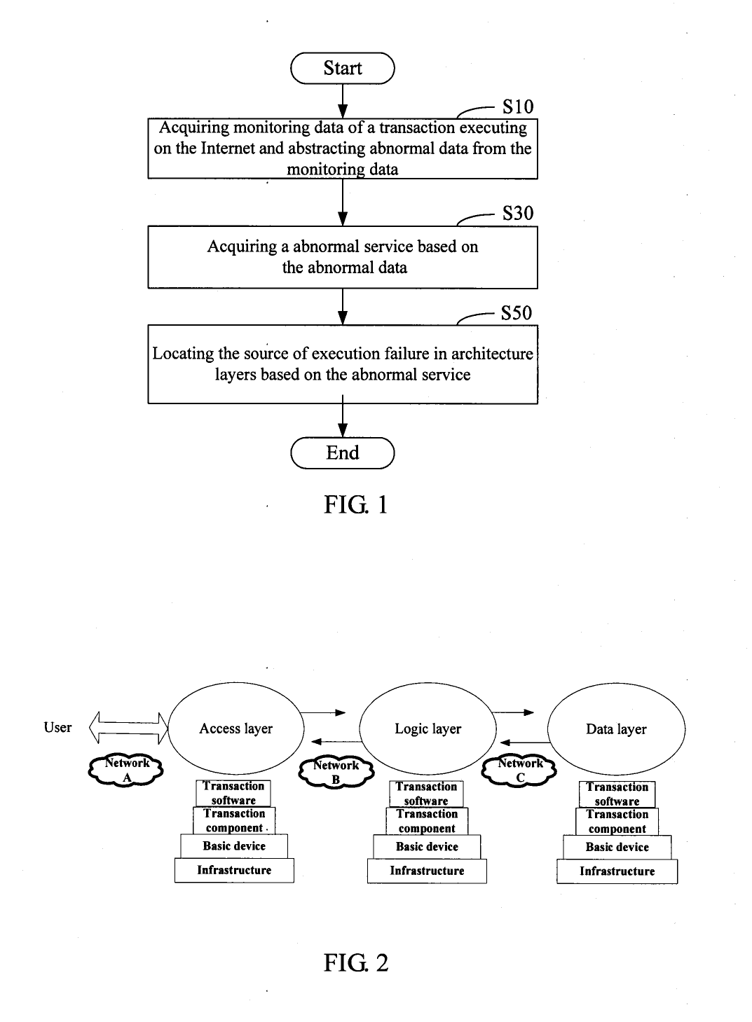

As shown in FIG. 1, in an embodiment, the method for monitoring transaction execution on the Internet comprises the following steps:

Step S10: acquiring monitoring data of a transaction executing on the Internet and abstracting abnormal data from the monitoring data.

In the embodiment, the monitoring data of the transaction is acquired by monitoring the execution process of the transaction, wherein the monitoring data is configured for explicitly indicating whether the transaction is healthy. For example, the monitoring data can be the number of online users, the number of complaints by users, the delay induced when a user accesses a web page, and so on. The monitoring data comprises data produced by the normal execution state and abnormal data produced by the abnormal execution. For example, the abnormal data can be data indicating that a web page is inapplicable.

Step S30: acquiring an abnormal service based on the abnormal data.

In the embodiment, in the execution process of the transaction, multiple functions are provided for a user via various services. For example, in a transaction, various small functions provided by multiple services form a processing capability owned by an application. The abnormal service in which a failure occurs is acquired based on the abstracted abnormal data, and the source inducing the failures in the service is found by subsequent processing.

S50: locating the source of execution failure in architecture layers based on the abnormal service.

In the embodiment, the architecture hierarchy of the transaction execution comprises an access layer, a logic layer, and a data layer, wherein the logic layer provides the user with the page for displaying the interface and makes response to variety requests of the user, and then proceeds logic processing, and the data layer is responsible for data storage, the transaction executed in the architecture hierarchy responds to the variety requests of the user. In particular, the architecture hierarchy is a layered model that comprises the access layer, the logic layer and the data layer in sequence from the front end to the back end. Wherein, the access layer is configured for receiving requests from a user and forwarding the requests from the user to the logic layer; the logic layer is configured for processing user request inputted from the access layer, performing logic processing for the transaction by using data stored in the data layer, and returning the processing result to the access layer; and the data layer is configured for temporarily or persistently storing data.

As shown in FIG. 2, each of the access layer, the logic layer, and the data layer comprises elements such as transaction software, transaction components, basic networks, basic devices and infrastructures etc. Wherein, the transaction components are public domain software packets or software architecture packets (for example, WebServer components, network communicating components, database components, etc.); the transaction software executes on the transaction components, and most of the transaction software are programs directly provided for the user's access (for example, Common Gateway Interface (CGI) providing a page displaying an interface for a user); the basic devices are devices such as servers, switches, routers, etc.; and the infrastructures are data center, electrical supply equipments, data center space, etc.

Furthermore, the architecture hierarchy of the transaction can also perform configuration of architecture hierarchy as transaction software layer, a transaction component layer, a basic device layer, and an infrastructure layer, and will not be divided into the access layer, the logic layer, and the data layer.

In the architecture hierarchy of the transaction, in addition to detecting the architecture layer in which the abnormal service exists, multiple architecture layers related with the abnormal service should also be detected for abnormality in order to locate the source of execution failure, and obtain the failure source inducing an abnormality in the service.

In the above method for monitoring transaction execution, the processing of acquiring a corresponding abnormal service based on the abnormal data in the monitoring data and locating the source of execution failure in related architecture layers based on the abnormal service is not simply locating the abnormal service as the source of execution failure in the execution of the transaction on the Internet, but to correspondingly detect the architecture layers related with the abnormal service to locate the source of execution failure, which improves the monitoring accuracy, and further facilitates the maintenance of the transaction executing on the Internet.

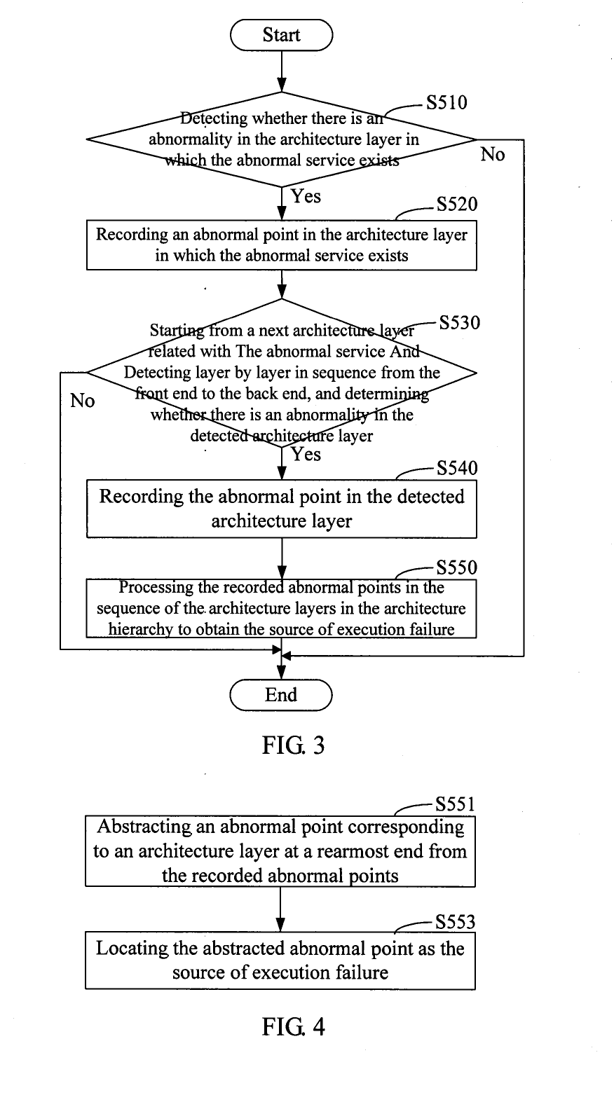

As shown in FIG. 3, in an embodiment, the specific processing of the above step S50 comprises:

Step S510: detecting whether an abnormality exists in the architecture layer in which the abnormal service exists; if so, proceeding to step S520; or else, the process ends.

In the embodiment, it is to detect whether respective segments in the architecture layer in which the abnormal service exists are abnormal, and record the abnormal points appearing in the architecture layer. Different architecture layers and different elements in an architecture layer correspond to different abnormal points. Specifically, an abnormal point is a description of an abnormal phenomenon, which is configured for determining whether an architecture layer and elements in thereof are abnormal. For example, for a basic device in an architecture layer, the abnormal point is that a server cannot be connected; and for a basic network, the abnormal point is that the packet loss rate of the network is larger than 30%.

Step S520, recording the abnormal point in the architecture layer in which the abnormal service exists.

Step S530, starting from a next architecture layer related with the abnormal service, performing the detection layer by layer in a sequence from the front end to the back end, and determining whether there exists any abnormality in the detected architecture layer; if so, then proceeding to step S40, or else, the process ends.

In the embodiment, a service in an architecture layer is usually dependent on a service(s) in a next architecture layer under the former layer so as to implement a corresponding function, these services are called downstream services. Therefore, it is necessary to detect layer by layer which starts from the next architecture layer to obtain the abnormal points existed in each architecture layer. Specifically, detecting each architecture layer in a sequence from the front end to the back end, and determining whether the detected architecture layer has a downstream service. If so, then it is further determined whether there is an abnormal point in the downstream service. It there is an abnormal point in the downstream service, the abnormal point is recorded. Wherein, in the architecture hierarchy of the executed transaction, the sequence from the front end to the back end refers to the sequence of the layers ordered as access layer, logic layer, and data layer, or to the sequence of transaction software, transaction component, basic device and infrastructure.

In another embodiment, the above step S50 further comprises:

determining on the architedure layer where the abnormal service locates whether there is a next architecture layer related with the abnormal service; if so, then proceeding to step S530; or else, locating the abnormal point recorded as the source of execution failure.

In the embodiment, when it is determined that an abnormal service normally operates independent of services in a next architecture layer, an abnormal point in the architecture layer in which the abnormal service exists is the source of execution failure, and it is unnecessary to detect layer by layer, so the efficiency of failure detecting is improved. Specifically, determining whether there is a service related with the abnormal service (i.e. a downstream service), the determined downstream service is highly associated with the abnormal service that performs the determination, and the abnormal service that performs the determination is operated under the dependency of the downstream service.

Step S540, recording the abnormal point in the detected architecture layer.

Step S550, processing the recorded abnormal points in sequence of the architecture layers in the architecture hierarchy to locate the source of execution failure.

In the embodiment, multiple recorded abnormal points are collected, and are processed in sequence from the front end to the back end in the architecture hierarchy to locate the source of execution failure. In the execution process of the transaction, an abnormal point appearing in any architecture layer may lead to the abnormal service. So collecting all abnormal points can determine the most possible failure cause and implement correlation analysis of respective architecture layers. Specifically, several recorded abnormal points are analyzed in association in the sequence of the architecture layers in the architecture hierarchy obtain the source of execution failure.

In the above method for monitoring transaction execution on the Internet, the most possible failure cause is determined by collecting all abnormal points to implement correlation analysis of respective architecture layers. That is, relatively discrete abnormal points are considered, so an accurate failure cause is obtained.

In an embodiment, the specific processing of the above step S550 comprises: abstracting an abnormal point corresponding to a maximum priority as the source of execution failure from the recorded abnormal points based on priorities corresponding to the architecture layers.

In the embodiment, a priority can be preset for each architecture layer, the priority being configured for identifying the possibility of an abnormal point inducing an abnormal service in an architecture layer. That is to say, the priority also represents an influence factor inducing an abnormal service. An abnormal point having a maximum priority is an abnormal point having a maximum influence factor inducing an abnormal service, the possibility of becoming the source of execution failure of which is the maximum. Therefore, the abnormal point having the maximum priority can be abstracted from the recorded abnormal points based on priorities corresponding to the architecture layers, and the source of execution failure can be located based on the abstracted abnormal point.

As to multiple abnormal points having the maximum priority, it is further determined which one of the multiple abnormal points is the source of execution failure based on priorities of elements in an architecture layer. For example, if a failure occurs in an infrastructure, the failure must influence the basic devices, the basic components and the basic software. Therefore, if there is an abnormal point in both an infrastructure and a basic device, the abnormal point in the infrastructure is preferably considered as the source of execution failure, etc.

As shown in FIG. 4, in another embodiment, the specific processing of the above step S550 comprises:

Step S551, abstracting an abnormal point corresponding to an architecture layer at a rearmost end from the recorded abnormal points.

In the embodiment, the abnormal point corresponding to the architecture layer at the rearmost end is abstracted from the recorded abnormal points based on the sequence of the architecture layers from the front end to the back end, and the abnormal point generated in the architecture layer at the rearmost end is taken as the source inducing the abnormal service.

Step S553, locating the abstracted abnormal point as the source of execution failure.

In an embodiment, the above method for monitoring transaction execution on the Internet further comprises presenting the source of execution failure and abnormal point in a failure locating page to facilitate viewing by the person maintaining the transaction.

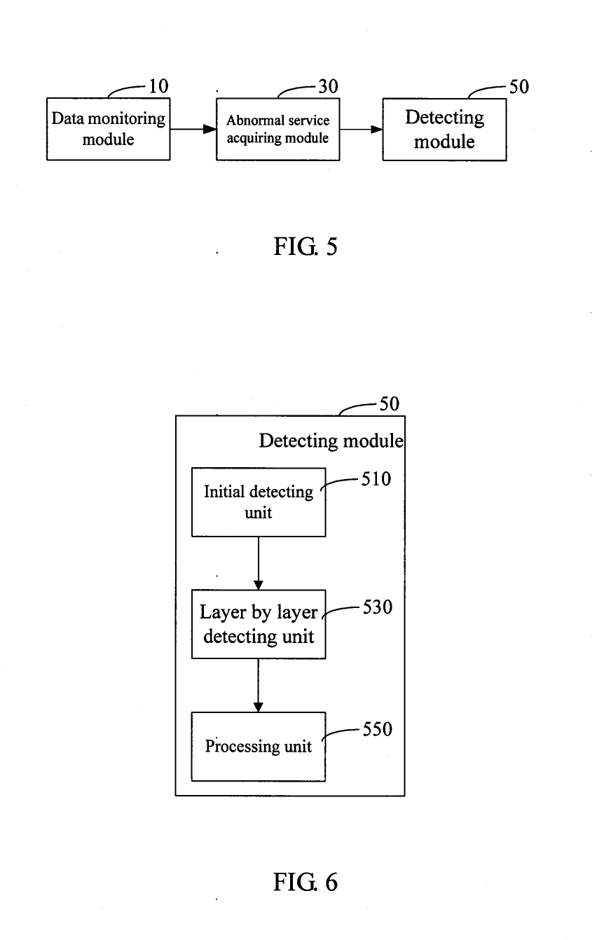

As shown in FIG. 5, in an embodiment, the system for monitoring transaction execution on the Internet comprises a data monitoring module 10, an abnormal service acquiring module 30, and a detecting module 50. Wherein:

The data monitoring module 10 is configured for acquiring monitoring data of a Internet transaction and abstracting abnormal data from the monitoring data.

In the embodiment, the monitoring data of the transaction is acquired by monitoring the execution process of the transaction, wherein the monitoring data is configured for explicitly indicating whether the execution of the transaction is healthy. For example, the monitoring data can be the number of online users, the number of complaints by users, the delay induced when a user accesses a web page, and so on. The monitoring data comprises data produced by the normal execution state and abnormal data produced by the abnormal execution. For example, the abnormal data can be data indicating that a web page is inapplicable.

The abnormal service acquiring module 30 is configured for acquiring an abnormal service based on the abnormal data.

In the embodiment, in the execution process of the transaction, multiple functions are provided for a user via various services. For example, in a transaction, various small functions provided by multiple services form a processing capability owned by the application. The abnormal service acquiring module 30 acquires the abnormal service where failure occurs based on the abstracted abnormal data, and the source inducing the abnormal service is found out by subsequent processing.

The detecting module 50 is configured for locating the source of execution failure in architecture layers based on the abnormal service.

In the embodiment, the architecture hierarchy of the transaction execution comprises an access layer, a logic layer, and a data layer, wherein the logic layer provides the user with the page for displaying the interface and makes response to variety requests of the user, and then proceeds logic processing, and the data layer is responsible for data storage, the transaction executed in the architecture hierarchy responds to the variety requests of the user. In particular, the architecture hierarchy is a layered model that comprises the access layer, the logic layer and the data layer in sequence from the front end to the back end. Wherein, the access layer is configured for receiving requests from a user and forwarding the requests from the user to the logic layer; the logic layer is configured for processing user request inputted from the access layer, performing logic processing for the transaction by using data stored in the data layer, and returning the processing result to the access layer; and the data layer is configured for temporarily or persistently storing data.

Each of the access layer, the logic layer, and the data layer comprises elements such as transaction software, transaction components, basic networks, basic devices and Infrastructures etc. Wherein, the transaction components are public domain software packets or software architecture packets; the transaction software executes on the transaction components, and most of the transaction software are programs directly provided for the user for accessing; the basic devices are devices such as servers, switches, routers and so on; and the infrastructures are data center, electrical supply equipments, data center space and so on.

Furthermore, the architecture system of the transaction can also directly set the architecture hierarchy as a transaction software layer, a transaction component layer, a basic device layer and an infrastructure layer, and is not divided into the access layer, the logic layer and the data layer any longer.

In the architecture system of the transaction, in addition to detecting whether an abnormality exists in the architecture layer in which the abnormal service exists, the detecting module 50 further detects multiple architecture layers related with the abnormal service for abnormality in order to locate the source of execution failure, and obtain the failure source inducing an abnormality in the service.

In the above system for monitoring transaction execution on the Internet, the processing of acquiring a corresponding abnormal service based on the abnormal data in the monitoring data and locating the source of execution failure in related architecture layers based on the abnormal service is not simply to take the abnormal service as the source of execution failure in the execution of the transaction on the Internet, but to correspondingly detect the architecture layers related with the abnormal service to locate the source of execution failure, which improves the monitoring accuracy, and further facilitates the maintenance of the transaction executing on the Internet is further facilitated.

As shown in FIG. 6, the above detecting module 50 comprises an initial detecting unit 510, a layer by layer detecting unit 530, and a processing unit 550.

The initial detecting unit 510 is configured for detecting whether an abnormality exists in the architecture layer, in which the abnormal service exists; if so, then recording the abnormal point in the architecture layer in which the abnormal point exists; or else, stopping execution.

In the embodiment, the initial detecting unit 510 detects whether respective segments in the architecture layer in which the abnormal service exists are abnormal, and records abnormal points appearing in the architecture layer. Different architecture layers and different elements in an architecture layer correspond to different abnormal points. Specifically, an abnormal point is a description of an abnormal phenomenon, which is configured for determining whether an architecture layer and elements in the architecture layer are abnormal.

The layer by layer detecting unit 530 is configured for starting from a next architecture layer related with the abnormal service and determining whether there is an abnormality in the detected architecture layer in sequence from the front end to the back end layer by layer; if so, then recording the abnormal point in the detected architecture layer.

In the embodiment, a service in an architecture layer is usually dependent on a service(s) in a next architecture layer relatively below the former layer to implement a corresponding function, these service(s) are referred to as downstream service. Thus, it is necessary for the layer by layer detecting unit 530 to detect layer by layer whether there is an abnormal point in the detected architecture layer starting from the next architecture layer of the architecture layer in which the abnormal service exists. Specifically, the layer by layer detecting unit 530 detects each architecture layer in sequence from the front end to the back end, and determines whether there is a downstream service in the detected architecture layer. If so, then it is further determined whether there is an abnormal point in the downstream service. It there is an abnormal point in the downstream service, the abnormal point is recorded. Wherein, in the architecture hierarchy of the executed transaction, the sequence from the front end to the back end refers to the sequence of the layers ordered as access layer, logic layer, and data layer, or to the sequence of transaction software, transaction component, basic device and infrastructure.

The processing unit 550 is configured for processing the recorded abnormal points to locate the source of execution failure in accordance with the sequence of the architecture layers in the architecture hierarchy.

In the embodiment, the processing unit 550 collects multiple recorded abnormal points, and processes them in sequence from the front end to the back end in the architecture hierarchy to locate the source of execution failure. In the execution process of the transaction, an abnormal point appearing in any architecture layer may lead to the abnormal service. So collecting all abnormal points can determine the most possible failure cause and implement correlation analysis of respective architecture layers. Specifically, the processing unit 550 analyzes several recorded abnormal points in association in the sequence of the architecture layers in the architecture hierarchy to obtain the source of execution failure.

In the above system for monitoring transaction execution on the Internet, the most possible failure cause is determined by collecting all abnormal points together to implement correlation analysis of respective architecture layers. That is, relatively discrete abnormal points are considered, so an accurate failure cause is obtained.

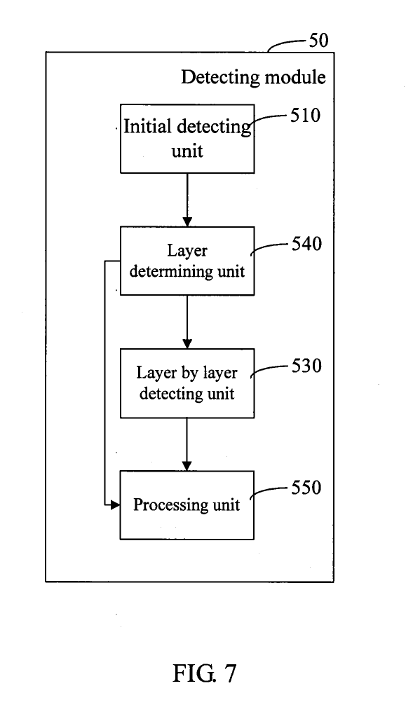

As shown in FIG. 7, the above detecting module 50 further comprises a layer determining unit 540 for determining whether there is a next architecture layer relative to the architecture layer where the abnormal service occurs related with the abnormal service, and if so, informing the layer by layer detecting unit 530, or else informing the processing unit 550.

In the embodiment, when the layer determining unit 540 determines that an abnormal service normally operates independent of a service(s) in a next architecture layer, an abnormal point in the architecture layer in which the abnormal service exists is the source of execution failure, and it is unnecessary to detect layer by layer, so the efficiency of failure detecting is improved. Specifically, the layer determining unit 540 determines whether there is a service related with the abnormal service (i.e. a downstream service) in the next architecture layer, and determines whether the downstream service is highly associated with the abnormal service to be located, and the abnormal service to be located is operated on the dependency of the downstream service.

The above processing unit 550 is further configured for locating the recorded abnormal point as the source of execution failure.

In an embodiment, the above processing unit 550 is further configured for abstracting an abnormal point corresponding to a maximum priority as the source of execution failure from the recorded abnormal points in accordance with priorities corresponding to the architecture layers.

In the embodiment, a priority can be preset for each architecture layer, the priority being configured for identifying the possibility of an abnormal point inducing an abnormal service in an architecture layer. That is to say, the priority also represents an influence factor inducing an abnormal service. An abnormal point having a maximum priority is an abnormal point having a maximum influence factor causing a service abnormal, the possibility of becoming the source of execution failure of which is the maximum. Therefore, the processing unit 550 can abstract the abnormal point having the maximum priority from the recorded abnormal points based on priorities corresponding to the architecture layers, and thus locate the failure source based on the abstracted abnormal point.

As to multiple abnormal points having the maximum priority, the processing unit 550 further determines which one of the multiple abnormal points is the source of execution failure based on priorities of elements in an architecture layer. For example, if a failure occurs in an infrastructure, the failure must influence the basic devices, the basic components and the basic software. Therefore, if there is an abnormal point in both an infrastructure and a basic device, the abnormal point in the infrastructure is preferably considered as the source of execution failure, and so on.

In another embodiment, the above processing unit 550 is further configured for abstracting an abnormal point corresponding to the architecture layer at the rearmost end from the recorded abnormal points, and locating the abstracted abnormal point as the source of execution failure.

In the embodiment, the processing unit 550 abstracts the abnormal point corresponding to the architecture layer at the rearmost end from the recorded abnormal points in sequence from the front end to the back end in the architecture hierarchy, and takes the abnormal point in the architecture layer at the rearmost back end as the source causing the service abnormal.

In an embodiment, the above system for monitoring transaction execution on the Internet further comprises presenting the source of execution failure and its corresponding abnormal point in a failure locating page to facilitate viewing by the person maintaining the transaction.

In the above described method and system for monitoring transaction execution on the Internet and the computer storage device thereof, architecture layers associated with the abnormal service are detected in accordance with the architecture hierarchy to obtain the source of the execution failure, so as to learn whether a failure occurring in each architecture layer is a primary factor for causing the abnormal service. So the execution failure can be accurately located in the multiple architecture layers, and it is unnecessary for the person maintaining the transaction to analyze the contents of a large number of alarms one by one.

The invention further provides a computer storage medium storing computer executable instructions, wherein the computer executable instructions are operable for controlling a computer to implement the above method for monitoring transaction execution on the Internet, specific steps of which are described above and thus are omitted herein.

The above embodiments are merely several implementations of the invention, the descriptions of which are specific and in detail and cannot be considered as limiting the scope of the invention. It should be pointed out that the person skilled in the art can make some alterations and improvements to the invention without departing from the concept of the invention. The protection scopes of the invention are merely limited by the claims.

What is claimed is:

1. A method for monitoring transaction execution on the Internet, comprising the steps of:
acquiring monitoring data of a transaction executing on the Internet, and abstracting abnormal data from the monitoring data;
acquiring an abnormal service based on the abnormal data; and
locating a source of execution failure in architecture layers based on the abnormal service.

2. The method for monitoring transaction execution on the Internet of claim 1, wherein the step of locating the source of execution failure in the architecture layers based on the abnormal service comprises:
detecting whether there is an abnormality in an architecture layer in which the abnormal service exists, if so, then recording an abnormal point in the architecture layer in which the abnormal service exists;
starting from a next architecture layer associated with the abnormal service and detecting layer by layer in sequence from a front end to a back end, and determining whether the detected architecture, layer exists any abnormality, if so, then recording an abnormal point in the detected architecture layer;
processing the recorded abnormal points in sequence from the front end to the back end in the architecture hierarchy to locate the source of execution failure.

3. The method for monitoring transaction execution on the Internet of claim 2, wherein the step of locating the source of execution failure in the architecture layers based on the abnormal service further comprises:
determining whether there is a next architecture layer associated with the abnormal service at the architecture layer where the abnormal service occurs, if so, then performing the step of starting from the next architecture layer associated with the abnormal service and detecting in sequence from the front end to the back end layer by layer;
or else, locating the recorded abnormal point as the source of execution failure.

4. The method for monitoring transaction execution on the Internet of claim 2, wherein the step of processing the recorded abnormal points in sequence from the front end to the back end in the architecture hierarchy to locate the source of execution failure comprises:
abstracting an abnormal point corresponding to a maximum priority as the source of execution failure from the recorded abnormal points based on priorities corresponding to the architecture layers.

5. The method for monitoring transaction execution on the Internet of claim 2, wherein the step of processing the recorded abnormal points in sequence from the front end to the back end in the architecture hierarchy to locate the source of execution failure comprises:
abstracting an abnormal point corresponding to an architecture layer at a rearmost end from the recorded abnormal points;
locating the abstracted abnormal point as the source of execution failure.

6. The method for monitoring transaction execution on the Internet of claim 5, wherein, after the step of processing the recorded abnormal points in sequence from the front end to the back end in the architecture hierarchy to locate the source of execution failure of the transaction, the method further comprises:
presenting the source of execution failure and the abnormal point in a failure locating page.

7. A system for monitoring transaction execution on the Internet, comprising:
a data monitoring module configured for acquiring monitoring data of a transaction on the Internet, and abstracting abnormal data from the monitoring data;
an abnormal service acquiring module configured for acquiring an abnormal service based on the abnormal data; and
a detecting module configured for locating a source of execution failure o in architecture layers based on the abnormal service.

8. The system for monitoring transaction execution on the Internet of claim 7, wherein the detecting module comprises:
an initial detecting unit configured for detecting whether there is an abnormality in an architecture layer in which the abnormal service exists, if so, then recording an abnormal point in the architecture layer in which the abnormal service exists;
a layer by layer detecting unit configured for starting from a next architecture layer associated with the abnormal service and detecting layer by layer in sequence from a front end to a back end, and determining whether there exists any abnormality on the detected architecture layer, if so, then recording an abnormal point in the detected architecture layer;
a processing unit configured for processing the recorded abnormal points in accordance with a sequence of the architecture layers in the architecture hierarchy to locate the source of execution failure.

9. The system for monitoring transaction execution on the Internet of claim 8, wherein the processing module further comprises:
a layer determining unit configured for determining whether there is a next architecture layer associated with the abnormal service at the architecture layer where the abnormal service occurs, if so, then informing the layer by layer detecting unit, or else, informing the processing unit; wherein
the processing unit is further configured for locating the abnormal point recorded as the source of execution failure.

10. The system for monitoring transaction execution on the Internet of claim 8, wherein the processing unit is further configured for abstracting an abnormal point corresponding to a maximum priority as the source of execution failure from the recorded abnormal points based on priorities corresponding to the architecture layers.

11. The system for monitoring transaction execution on the Internet of claim 8, wherein the processing unit is further configured for abstracting an abnormal point corresponding to an architecture layer at a rearmost end from the recorded abnormal points, and locating the abstracted abnormal point as the source of execution failure.

12. The system for monitoring transaction execution on the Internet of claim 11, wherein the system also presents the source of execution failure and the abnormal point in a failure locating page.

13. A computer readable storage medium for storing computer executable instructions, wherein the computer executable instructions are configured for controlling the method of monitoring the transactions on the Internet, wherein the method comprising:
acquiring monitoring data of a transaction on the Internet, and abstracting abnormal data from the monitoring data;
acquiring an abnormal service based on the abnormal data; and
locating a source of execution failure in architecture layers based on the abnormal service.

14. The computer readable storage medium of claim 13, wherein the step of locating the source of execution failure in the architecture layers based on the abnormal service comprises:
detecting whether there is an abnormality in an architecture layer in which the abnormal service exists, if so, then recording an abnormal point in the architecture layer in which the abnormal service exists;
starting from a next architecture layer associated with the abnormal service and detecting layer by layer in sequence from a front end to a back end, and determining whether the detected architecture layer exists any abnormality, if so, then recording an abnormal point in the detected architecture layer;
processing the recorded abnormal points in sequence from the front end to the back end in the architecture hierarchy to locate the source of execution failure.

15. The computer readable storage medium of claim 14, wherein the step of locating the source of execution failure in the architecture layers based on the abnormal service further comprises:
determining whether there is a next architecture layer associated with the abnormal service at the architecture layer where the abnormal service occurs, if so, then performing the step of starting from the next architecture layer associated with the abnormal service and detecting in sequence from the front end to the back end layer by layer;
or else, locating the recorded abnormal point as the source of execution failure.

16. The computer readable storage medium of claim 14, wherein the step of processing the recorded abnormal points in sequence from the front end to the back end in the architecture hierarchy to locate the source of execution failure further comprises:
abstracting an abnormal point corresponding to a maximum priority as the source of execution failure from the recorded abnormal points based on priorities corresponding to the architecture layers.

17. The computer readable storage medium of claim 14, wherein the step of processing the recorded abnormal points in sequence from the front end to the back end in the architecture hierarchy to locate the source of execution failure comprises:
abstracting an abnormal point corresponding to an architecture layer at a rearmost end from the recorded abnormal points;
locating the abstracted abnormal point as the source of execution failure.

18. The computer readable storage medium of claim 17, wherein after the step of processing the recorded abnormal points in sequence from the front end to the back end in the architecture hierarchy to locate the source of execution failure of the transaction, the computer executable instructions are further operable for:
presenting the source of execution failure and the abnormal point in a failure locating page.
